(19) United States
(12) Patent Application Publication
(10) Pub. No.: US 2009/0317590 A1
(43) Pub. Date: Dec. 24, 2009

(54) METHOD FOR FABRICATING SUPERHYDROPHOBIC SURFACE AND SOLID HAVING SUPERHYDROPHOBIC SURFACE STRUCTURE BY THE SAME METHOD

(75) Inventors: Woon-Bong Hwang, Gyungsangbuk-do (KR); Kun-Hong Lee, Gyungsangbuk-do (KR); Dong-Hyun Kim, Seoul (KR); Hyun-Chul Park, Gyungsangbuk-do (KR)

Correspondence Address: SHERIDAN ROSS PC, 1560 BROADWAY, SUITE 1200, DENVER, CO, 80202, US

(73) Assignee: POSTECH ACADEMY-INDUSTRY FOUNDATION, Pohang-city (KR)

(21) Appl. No.: 12/307,185

(22) PCT Filed: Jul. 5, 2007
(86) PCT No.: PCT/KR07/03275

§ 371 Date: Dec. 31, 2008

(30) Foreign Application Priority Data
Jul. 5, 2006 (KR) 10-2006-0062963

(51) Int. Cl. B32B 15/08; C25D 5/16

(52) U.S. Cl. 428/141; 205/85

(57) ABSTRACT

A method of processing a superhydrophobic surface and a solid body having the superhydrophobic surface processed by the method are provided. The method forming a plurality of nano-scale holes having nano-scale diameter on a surface of a metal body through an anode oxidation process, forming a replica by immersing the metal body provided with the nano-scale holes in a hydrophobic polymer material and solidifying the hydrophobic polymer material, and forming the superhydrophobic surface by removing the metal body with an anode oxide. The solid body includes a base, and a surface structure having micro-scale unevenness formed by a plurality of bunches formed by a plurality of adjacent pillars that are formed on the base and have a nano-scale diameter.

### BACKGROUND OF THE INVENTION

(a) Field of the Invention

The present invention relates to a method of processing a superhydrophobic surface and a solid body having the superhydrophobic surface processed by the method. More particularly, the present invention relates to a surface processing method using a surface treatment of a metal body, a replication process, and a polymer sticking phenomenon, and to a solid body having a surface processed by the surface processing method.

(b) Description of the Related Art

Generally, a surface of a solid body formed of metal or polymer has inherent surface energy. The inherent surface energy is represented as a contact angle between liquid and a surface of a solid body when the liquid contacts the surface of the solid body. When the contact angle is less than 90°, a spherical drop of liquid loses its shape to change into hydrophilicity wetting the surface of the solid body. When the contact angle is greater than 90°, the spherical drop maintains its spherical shape to have hydrophobicity that does not wet the solid body but easily flows. The hydrophobicity of the drop can be noted from a case where a drop of water falling on a lotus leaf does not wet the lotus leaf but flows along a surface of the leaf.

Meanwhile, the inherent contact angle of the surface of the solid body may be varied by processing the surface such that the surface has protrusions and depressions. That is, the hydrophilicity of the surface having the contact angle less than 90° may be further enhanced through a surface treatment process. Likewise, the hydrophobicity of the surface having the contact angle greater than 90° may be also further enhanced through the surface treatment process. The hydrophobicity surface of the solid body may be used for a variety of following applications. That is, the hydrophobicity surface can be applied to a condenser of an air conditioning system to enhance the condensing efficiency. When the hydrophobicity surface is applied to a drink can, the residue can be completely removed from the can and thus the recycling process of the can may be simplified. Further, when the hydrophobicity surface is applied to a window glass of a vehicle, it can prevent the window glass from being steamed up when there is a difference between an indoor temperature and an outdoor temperature. When the hydrophobicity surface is applied a ship, the ship can show a higher impellent force using the same power. Furthermore, when the hydrophobicity surface is applied to a dish antenna, it can prevent snow from covering a surface of the dish antenna. When the hydrophobicity surface is applied to a water supply pipe, the water flow rate can be improved.

However, a technology for varying the contact angle of the surface of the solid body in response to a specific purpose has been depending on a microelectromechanical system (MEMS) process applying a semiconductor fabrication technology. Therefore, this technology is generally used for a method for forming micro- or nano-scaled protrusions and depressions on the surface of the solid body. The MEMS process is an advanced mechanical engineering technology applying the semiconductor technology. However, the apparatus used for the semiconductor process is very expensive.

In order to form the nano-scaled protrusions and depressions on a surface of a solid metal body, a variety of processes, which cannot be performed under a normal working environment, such as a process for oxidizing the metal surface, a process for applying a constant temperature and a constant voltage, and a process for oxidizing and etching using a special solution, must be performed. That is, in order to such processes, a specifically designed clean room is required and a variety of expensive apparatus for performing the processes are necessary.

Furthermore, due to a limitation of the semiconductor process, a large surface cannot be processed at once. As described above, according to the conventional technology, the process is very complicated and it is difficult to mass-produce the products. Furthermore, the cost for producing the products is very high. Therefore, it is difficult to apply the conventional technology.

The above information disclosed in this Background section is only for enhancement of understanding of the background of the invention and therefore it may contain information that does not form the prior art that is already known in this country to a person of ordinary skill in the art.

### SUMMARY OF THE INVENTION

Exemplary embodiments of the present invention provide a method for processing a superhydrophobic surface, which can reduce the processing cost by mass-producible-processing the hydrophobic surface through a simple process.

Exemplary embodiments of the present invention also provide a solid body having a superhydrophobic surface that is replicated from a metal body nano-scale holes through the superhydrophobic surface processing method.

In an exemplary embodiment of the present invention, a method of processing a superhydrophobic surface includes, i) forming a plurality of nano-scale holes having nano-scale diameters on a surface of a metal body through an anodization process, ii) forming a replica by immersing the metal body provided with the nano-scale holes in a hydrophobic polymer material and solidifying the hydrophobic polymer material, and iii) forming the dual-scale superhydrophobic surface structure having both a microstructure and a nanostructure by removing the metal body with an anodic oxide.

An aspect ratio of the hole may be formed in the range from 100 to 1900, and preferably an aspect ratio of the hole may be formed in the range from 500 to 1700.

The replica may have a plurality of pillars having nano-scale diameter that are replicated by the hydrophobic polymer material filled in the nano-scale holes formed in the metal body.

The pillars may form a plurality of micro-scale bunchs as adjacent pillars are partly stuck to each other.

The hydrophobic polymer material may be selected from the group consisting of PTFE (Polytetrahluorethylene), FEP (Fluorinated ethylene propylene copolymer), PFA (Perfluoroalkoxy), and a combination thereof.

The metal body may be formed of an aluminum or aluminum alloy.

In another exemplary embodiment of the present invention, a solid body having superhydrophobic surface structure includes a base, and a surface structure having micro-scale unevenness formed by a plurality of bunches formed by a plurality of adjacent pillars that are formed on the base and have a nanometer sized diameter, such that the solid body has dual-scale structure having both nanostructure and microstructure.

An aspect ratio of the pillar having nano-scale diameter may be formed in the range from 100 to 1900, and preferably an aspect ratio of the pillar may be formed in the range from 500 to 1700. The micro-scale unevenness may be formed by the adjacent pillars having nano-scale diameter that are partly stuck to each other.

The pillars formed on the base may be formed of a hydrophobic polymer material.

The hydrophobic polymer material may be selected from the group consisting of PTFE (Polytetrahluorethylene), FEP (Fluorinated ethylene propylene copolymer), PFA (Perfluoroalkoxy), and a combination thereof.

### BRIEF DESCRIPTION OF THE DRAWINGS

FIGS. 1A through 1D are views illustrating a method of processing a superhydrophobic surface according to an exemplary embodiment of the present invention.

FIG. 2 is a schematic diagram of an anodic oxidation apparatus, illustrating an anodic oxidation process.

FIG. 3 shows top plan view and sectional views illustrating a state before and after an anodic oxidation process is performed.

FIG. 4 is an scanning electron microscope (SEM) image of a surface of a metal body that is provided with nano-scale holes formed through an anodic oxidation process.

FIGS. 5A and 5B are SEM images of a solid body having a superhydrophobic surface that is formed using a sticking phenomenon by van der Waals' force.

FIG. 6 is an image illustrating a contact angle between a drop of liquid and a superhydrophobic surface of a solid body according to an exemplary embodiment of the present invention.

FIG. 7 is SEM top images of untreated normal industrial aluminum and porous anodic alumina. FIG. 7(a) illustrates a surface of the untreated normal industrial aluminum, FIG. 7(b) illustrates a surface of the anodic alumina on which nano-scale holes are formed, and FIG. 7(c) is a cross-sectional image of anodic alumina.

FIG. 8 (a) through (d) are SEM cross images of porous anodic alumina template with 3, 6, 8, and 10 hr anodizing time, respectively.

FIG. 9 (a) through (d) are SEM surface images of the superhydrophobic PTFE nanostructure replicated from the porous anodic alumina template with 3, 6, 8, and 10 hr anodizing time, respectively.

FIG. 10 (a) through (d) show water droplets and contact angles on the surfaces of the superhydrophobic PTFE nanostructures of embodiment 1 (aspect ratio: 550), embodiment 2 (aspect ratio: 825), embodiment 3 (aspect ratio: 1125), embodiment 4 (aspect ratio: 1650), respectively.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention.

In the present invention, “micro-scale” size is defined as a size in the range equal to or more than 1 μm and less than 1000 μm, and “nano-scale” size is defined as a size in the range equal to or more than 1 nm and less than 1000 nm.

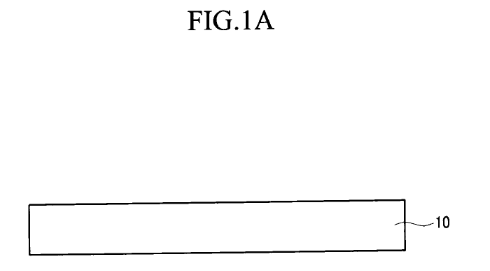

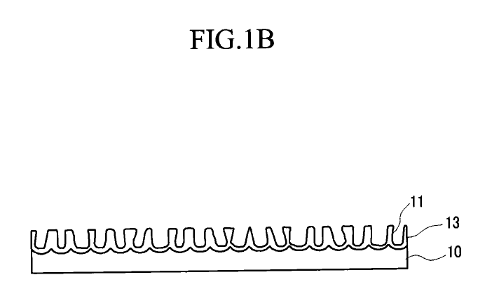

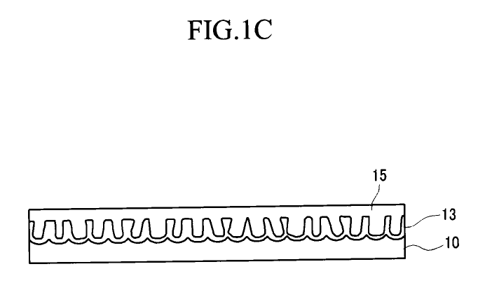

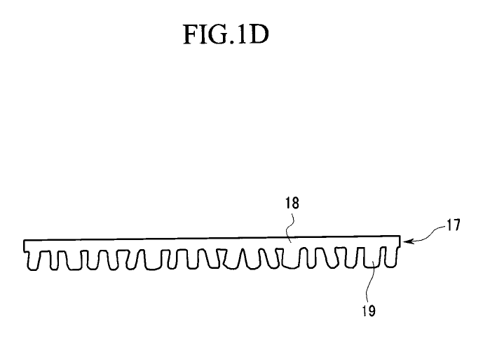

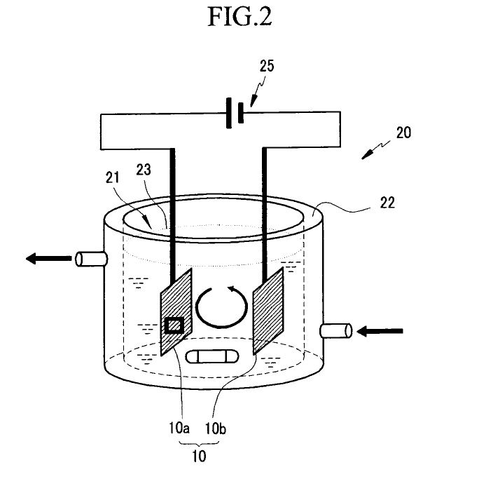

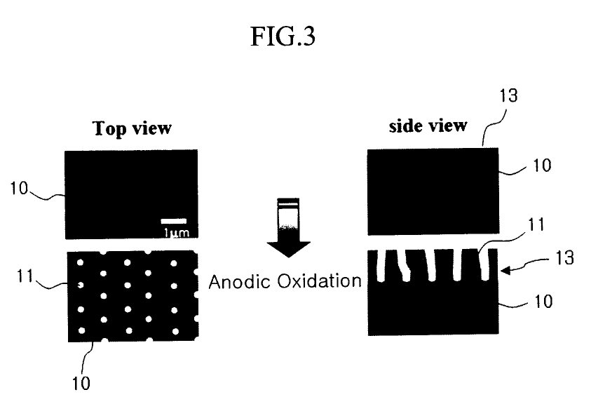

FIGS. 1A through 1D are views illustrating a method of processing a superhydrophobic surface according to an exemplary embodiment of the present invention, FIG. 2 is a schematic diagram illustrating an anodic oxidation process, and FIG. 3 shows top plan view and sectional views illustrating a state before and after the anodic oxidation process is performed.

The following will describe a method of processing a hydrophobic surface according to an exemplary embodiment of the present invention with reference to FIGS. 1A to 3.

First, as shown in FIG. 1A, a thin metal plate 10 is prepared, and, as shown in FIG. 2, the thin metal plate 10 is loaded in a receiving space 21 of an anodic oxidation apparatus 20. That is, the thin metal plate 10 is immersed in electrolyte solution 23 stored in the receiving space 21 of the anodic oxidation apparatus 20. The thin metal plate 10 may be formed of a conductive material such as aluminum or aluminum alloy, which can form a porous surface through an anodic oxidation process.

Next, the anodic oxidation apparatus 20 operates to treat a surface of the thin metal plate 10 through the anodic oxidation process. Referring to FIG. 2, the anodic oxidation apparatus 20 includes a main body 22 provided with the receiving space 23 for receiving a solid body (e.g., the thin metal plate 10) and storing the electrolyte solution 23, and a power source 25 for supplying cathode and anode voltages to the thin metal plate 10. In this exemplary embodiment, a pair of the thin metal plates 10 are loaded in the receiving space 23 of the main body 22.

In more detail, in the anodic oxidation process using the anodic oxidation apparatus 20, the solid body 10 is first immersed in the electrolyte solution 23 stored in the main body 22. Here, sulfuric acid, phosphoric acid or oxalic acid may be selectively used as the electrolyte solution 23 for the anodic oxidation process. The diameter of nano-scale hole and the distance between neighboring holes can be controlled depending upon the kind of the selected electrolyte solution.

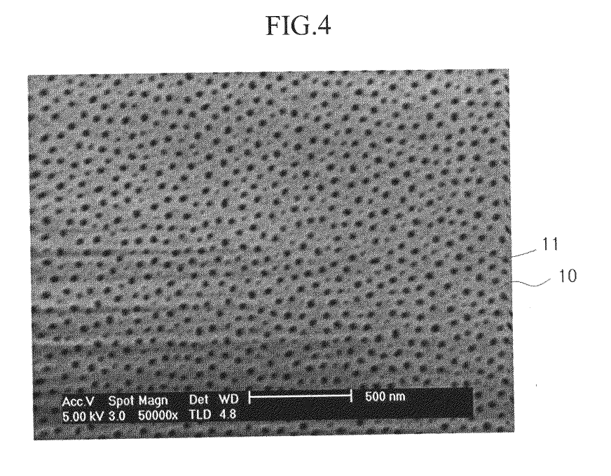

Next, one of the solid bodies 10a and 10b is applied with the anode voltage from the power source 25 and the other is applied with the cathode voltage from the power source 25. Therefore, as shown in FIG. 3, an anode oxide portion 13 is formed on the surface of the thin metal plate 10. When the thin metal plate 10 is formed of aluminum, alumina that is an oxide layer is formed on the surface of the thin metal plate 10. Nano-scale holes 11 each having a nano-scale diameter are formed in the anode oxide portion 13. FIG. 4 is a SEM image of a surface of a metal body that is provided with nano-scale holes through an anodic oxidation process. It can be noted from FIG. 4 that the nano-scale holes 11 each having a nanometer-sized diameter are formed in the thin metal plate 10.

Here, the depth of the hole 11 is controlled by the anodizing time. Though the depth per hour of the hole may be varied according to the characteristic of the electrolyte solution and the metal body, it is generally known that the depth of the anodic oxidation hole is proportional to anodizing time.

The aspect ratio of the hole can be controlled by controlling the depth of the anodic oxidation hole. Since the diameter of the hole is kept in uniform and the depth of the hole becomes deeper as the anodizing time becomes longer, the nano-scale hole formed on the metal body by anodizing for a long time may have high aspect ratio.

The aspect ratio of the hole may be formed in the range from 100 to 1900, and preferably the aspect ratio of the hole may be formed in the range from 500 to 1700. When the aspect ratio of the nano-scale hole is less than 100, the nano-scale pillar of the replica is difficult to form a bunch since the sticking phenomenon is weak, and when the aspect ratio of the nano-scale hole is more than 1900, the nano-scale pillar is lying down and stacked to become solid state. Aspect ratio of the nano-scale pillar of the replica, which is to be explained below, depends on the aspect ratio of the nano-scale hole.

Next, the thin metal plate 10 that is treated through the anodic oxidation process is immersed in a hydrophobic polymer solution 15. Here, the hydrophobic polymer solution 15 may be selected from the group consisting of polytetrahluorethylene (PTFE), fluorinated ethylene propylene copolymer (PEP), perfluoroalkoxy (PFA), and a combination thereof. After the above, when the hydrophobic polymer solution is solidified in a state where the metal thin plate 10 is immersed therein, a hydrophobic polymer replica 15 is formed as shown in FIG. 1C.

Next, the thin metal plate 10 and the anode oxide portion 13 are removed from the hydrophobic polymer replica 15. When the thin metal plate is formed of aluminum and thus the anode oxide portion is the alumina, the metal plate and the alumina can be removed through a wet-etching process. Accordingly, replica of a surface shape of the metal plate 10 is realized on the surface of the hydrophobic polymer replica 18, thereby making it possible to form a polymer solid body 17 having a superhydrophobic surface with extremely low wettability.

As shown in FIG. 1D, the polymer solid body 17 includes a base 18 and a plurality of pillars 19 formed on the base and each having a diameter identical to the diameter of the nano-scale hole 11. As each of the pillars 19 has a nanometer-sized diameter, attraction is generated between the adjacent pillars 19. That is, by van der Walls' force that is attraction generated when a distance between adjacent members is extremely short, a phenomenon where the adjacent pillars 19 are stuck to each other occurs. By the sticking phenomenon, the pillars 19 of the polymer solid body 17 form a plurality of bunches that are settled down as a whole. As a result, the polymer solid body 17 having micro-scale surface formed with the pillars having nano-scale diameter can be obtained. Thus, a polymer solid body having dual-scale structure surface can be obtained.

The aspect ratio of the nano-scale pillar 19 may be formed in the range from 100 to 1900, and preferably the aspect ratio of the nano-scale pillar 19 may be formed in the range from 500 to 1700. When the aspect ratio of the nano-scale pillar 19 is less than 100, the nano-scale pillar of the replica is difficult to form a bunch since the sticking phenomenon is weak, and when the aspect ratio of the nano-scale pillar is more than 1900, the nano-scale pillar is lying down and stacked to become solid state and the effect of nano-scale is difficult to expect.

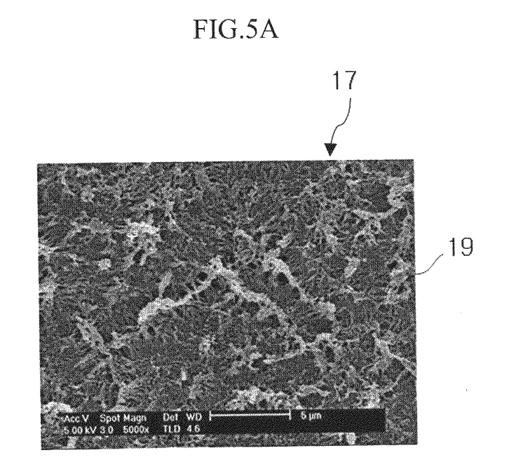

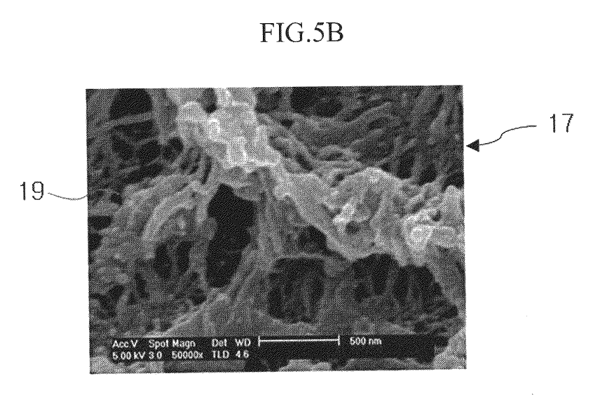

FIGS. 5A and 5B are SEM images of a solid body having a superhydrophobic surface that is formed using a sticking phenomenon by van der Walls' force. From pictures of FIGS. 5A and 5B, it can be noted that the pillars 19 are stuck to each other on the surface of the polymer solid body 17 and irregularly settled down.

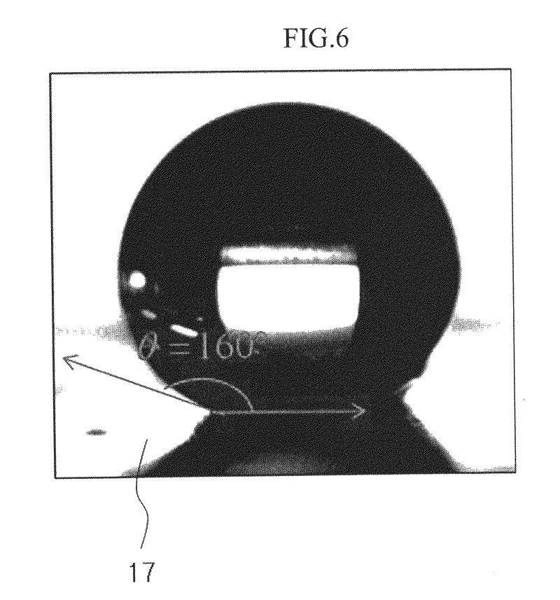

The solid body 17 having the above-described surface structure has minimum wettability through a structural surface treatment rather than a chemical coating process. When a drop of water is applied on the surface of the solid body 17 and a contact angle between the drop and the surface is measure, it can be noted that the contact angle is significantly increased up to 160° as shown in FIG. 6. Generally, a contact angle between a drop of fluid and a surface of a solid body that is not processed is about 83°. Therefore, according to the exemplary embodiment of the present invention, it can be noted that, since the contact angle is significantly increased, the surface of the solid body has superhydrophobicity having minimum wettability.

### EXPERIMENTAL EXAMPLE

Preparation of Treated Al and Replica

We began with an industrial aluminum sheet (99.5%) of size 50 mm×40 mm. The first step is anodization, carried out in 0.3 M oxalic acid solution. The aluminum sheet was used as the anode, and a flat platinum sheet as the cathode. The electrodes were placed about 5 cm apart. A DC voltage of 40V was applied between the electrodes by a computer-interfaced power supply (Digital electronics CO., LTD., DRP-92001DUS). During anodization the solution was maintained at 15° C. by a circulator (Lab. Companion, RW-0525G), and was agitated using stirrer (Global Lab, GLHRS-G) in order to prevent density of solution from locally unbalancing.

The anodized specimens was dried in an oven of 60° C. for about an hour after washed in deionized water for about 15 minutes. Depth of anodic aluminum oxide hole is controlled by anodizing time, and the anodic oxidation proceeds with 100 nm depth per minute. Four anodized porous alumina specimens were prepared for this experimental example. The specimens were anodized for 3, 6, 8 and 10 hours (embodiment 1, embodiment 2, embodiment 3, and embodiment 4, respectively). The anodic aluminum oxide becomes nano-scale honeycomb structure.

The next step is the replication. The nano-scale honeycomb structure (anodic aluminum oxide, AAO) was used as the template material. To make a polymer replica, the dipping method was used with the mixed solution of PTFE (0.3 wt %) and the solvent, which comprises a solution of 6 wt % PTFE (Polytetrafluoroethylene, DuPont Teflon® AF: Amorphous Fluoropolymer Solution) in the solvent (ACROS, FC-75). The template was dipped into the mixed solution, and cured at room temperature. During the curing process, the solvent of the mixed solution was evaporated, and PTFE thin film remained.

The final step is removal of the nano-scale honeycombe template (AAO template). The aluminum layer was removed in HgCl₂ solution. Residual porous alumina was then removed in a mixture of 1.8 wt % chromic acid and 6 wt % phosphoric acid at 65° C. for 5 hours.

Surface Characterization

The sessile drop method, which measures the contact angle (CA) of a water droplet on a surface, was used to characterize the wetting properties of the resulting micro/nanostructures. A surface analyzer, DSA-100 (Krüss Co.), was used for the measurement. Steady-state contact angles were measured using a 3 μL deionized water droplet. At least five different measurements were performed on different areas of each specimen at room temperature.

Topography of the Treated Al Surface and Replica

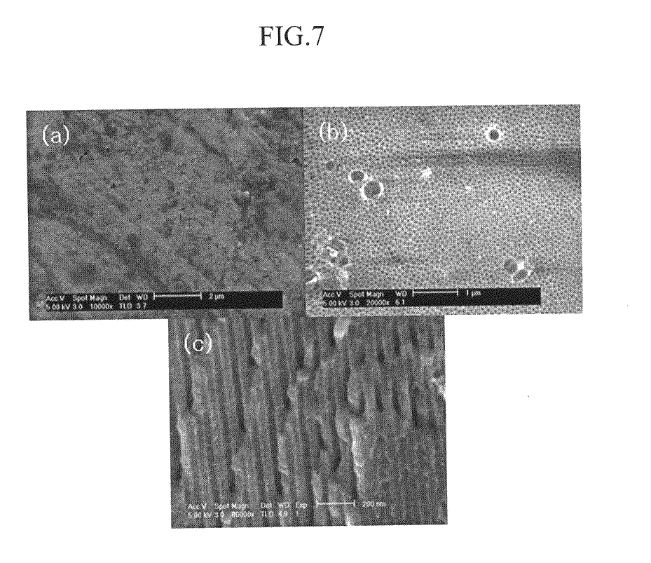

FIG. 7 illustrates SEM images of a normal industrial aluminum and an anodic aluminum oxide template. FIG. 7(a) shows a surface of untreated normal industrial aluminum. FIG. 7(b) shows nano-scale holes on a surface of an anodic aluminum oxide. The anodizing was carried out at 40 V in a 0.3 M oxalic acid solution at 15° C. for 6 hr. FIG. 7(c) shows a cross-section image of an anodic aluminum oxide.

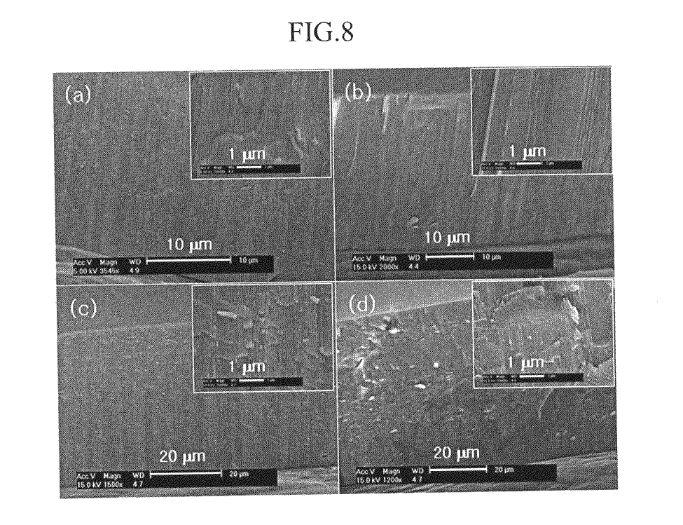

FIG. 8 (a) through (d) are SEM cross images of porous anodic alumina template with 3, 6, 8, and 10 hr anodizing time, respectively, and the depths of the porous anodic alumina of the four specimens are 22, 33, 45, and 66 μm shown in FIG. 8(a)-(d). The diameter of the hole is 40 nm, and the distance between the neighboring holes is approximately 100 nm. The length and density of the replicated nanowire depends on each depth of the anodic aluminum oxide template controlled during the replication process. Each hole of the fabricated anodic aluminum oxide template has high aspect ratio of 550, 825, 1125, and 1650 respectively, which causes polymer sticking phenomenon.

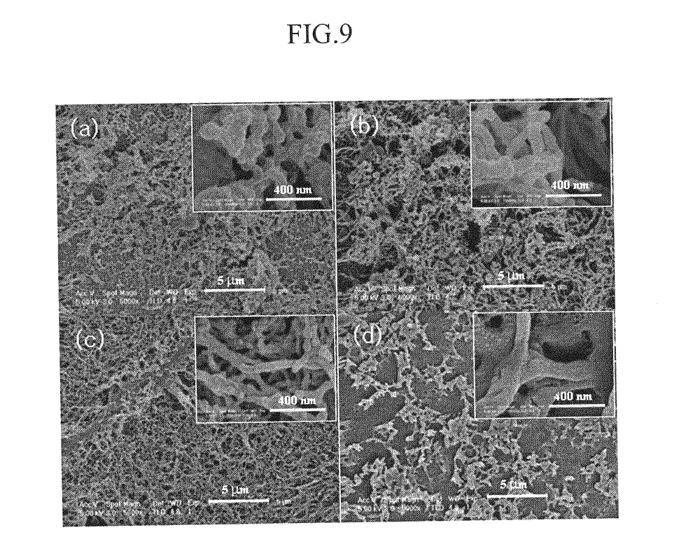

FIG. 9 is SEM surface images of the superhydrophobic PTFE nano-scale structure replicated from the porous anodic alumina template. The specimen with 3, 6, 8, and 10 hr anodizing time is defined as embodiment 1, embodiment 2, embodiment 3, and embodiment 4, respectively, and FIG. 9 (a) through (d) show each surface of the specimen. FIG. 9 shows that PTFE replication is carried out successfully.

Anodic aluminum oxide template is a structure having high aspect ratio, and PTFE structure replicated from the template becomes nano-scale pillar structure. However, the length of the wire of nano-scale pillar structure formed on each specimen is 22, 33, 45, and 66 μm, and high aspect ratio (550, 825, 1125, and 1650 for each embodiment 1˜4) causes polymer sticking phenomenon. Such a polymer sticking phenomenon leads to the sunken and curved nano-wire entanglement and bunch, to form a micro-scale structure.

Wetting Properties

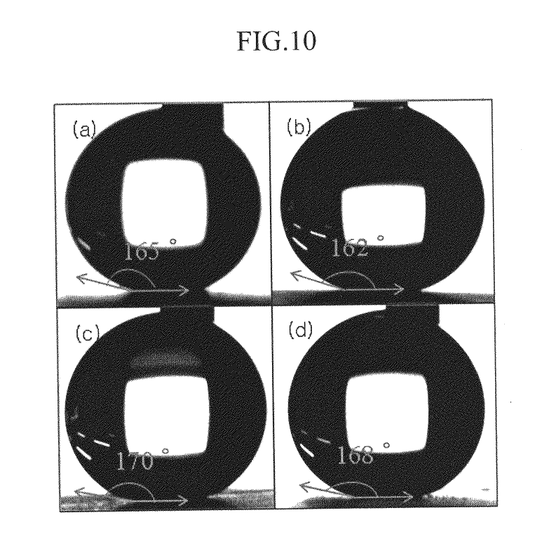

FIG. 10 shows measured values of the contact angle. The contact angles of the fabricated superhydrophobic PTFE nanostructure embodiment 1 (aspect ratio 550), embodiment 2 (aspect ratio 825), embodiment 3 (aspect ratio 1125), and embodiment 4 (aspect ratio 1650) are respectively 165°, 162°, 170° and 168°. These were average values of the measured contact angle. The errors were less than 2°. The intrinsic contact angle of PTFE is 120°, so that the dual-scale structure having both the micro-scale bunches and the nano-scale sunken and curved wire increases the hydrophobicity.

The water droplets on these dual-scaled modified surfaces readily sit on the apex of the nanostructures, since air fills the space of the microstructures under a water droplet. A water droplet on these dual-scaled modified surfaces can not penetrate into the surface. Therefore, the nano-wire entanglement and bunch structures dramatically reduce the contact area between the water droplet and the solid surface, and have the extreme superhydrophobicity.

The contact angle of embodiment 3 (aspect ratio 1125) is 170°, which is the largest contact angle. This can be explained as follows referring to FIG. 9(a) to (d). From FIG. 9(a)-(d), the specimen shown in FIG. 9(c), embodiment 3 (aspect ratio 1125), has the densest nano-scale entanglement structures. This means that the space filled by air is the largest, and the total area of contact with the water droplet is the smallest, which increased the superhydrophobicity.

We found that water droplets cannot fix stably on the PTFE replica surfaces. This represented that a resistance between the surface and the water droplets, and the roll off angle, which is another variable representing superhydrophobicity, is measured less than 1°. The contact angles were determined in the syringe-water droplet-replica surface equilibrium condition.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

The method of processing a superhydrophobic surface and a solid body having the superhydrophobic surface processed by the method according to exemplary embodiments of the present invention have the following effects.

First, by performing the replication process through a process for immersing the metal body provided with nano-scale holes that are formed through an anode oxidation process in a hydrophobic material and for solidifying the hydrophobic material, the replica can be easily and simply produced with the low cost material and the simple process. Therefore, a solid body having a superhydrophobic surface can be easily produced using the replica, thereby reducing the production cost.

Second, the solid body having the superhydrophobic surface has a self-cleaning function. Therefore, when the solid body is applied to a condenser of an air conditioning system, condensing efficiency of the condenser can be improved. Further, when the solid body is applied to a drink can, the residue can be completely removed from the can and thus the recycling process of the can may be simplified. Further, when the solid body is applied to a window glass of a vehicle, the steaming of the window can be prevented when there is a difference between an indoor temperature and an outdoor temperature. In addition, when the solid body is applied a ship, the ship can show a higher impellent force using the same power. Furthermore, when the solid body is applied to a dish antenna, the covering of a surface of the dish antenna by snow can be prevented. In addition, when the solid body is applied to a water supply pipe, the water flow rate can improved.

What is claimed is:

1. A method of processing a superhydrophobic surface, comprising:
forming a plurality of nano-scale holes having nano-scale diameter on a surface of a metal body through an anodic oxidation process;
forming a replica by immersing the metal body provided with the nano-scale holes in a hydrophobic polymer material and solidifying the hydrophobic polymer material; and
forming the superhydrophobic dual-scale surface having both nanostructure and microstructure by removing the metal body and an anodic oxide from the replica.

2. The method of claim 1, an aspect ratio of the nano-scale hole may be formed in the range from 100 to 1900.

3. The method of claim 2, an aspect ratio of the nano-scale hole may be formed in the range from 500 to 1700.

4. The method of claim 1, wherein the replica has a plurality of pillars having nano-scale diameter that are replicated by the hydrophobic polymer material filled in the nano-scale holes formed in the metal body.

5. The method of claim 4, wherein the pillars form a plurality of micro-scale bunches as adjacent pillars are partly stuck to each other.

6. The method of claim 1, wherein the hydrophobic polymer material is selected from the group consisting of PTFE (Polytetrahluorethylene), FEP (Fluorinated ethylene propylene copolymer), PFA (Perfluoroalkoxy), and a combination thereof.

7. The method of claim 1, wherein the metal body is formed of an aluminum or aluminum alloy.

8. A solid body having superhydrophobic surface structure comprising:
a base; and
a surface structure having micro-scale unevenness formed by a plurality of bunches formed by a plurality of adjacent pillars that are formed on the base and have a nano-scale diameter, such that the solid body has dual-scale structure having both nanostructure and microstructure.

9. The solid body of claim 8, an aspect ratio of the pillar having nano-scale diameter may be formed in the range from 100 to 1900.

10. The solid body of claim 8, an aspect ratio of the pillar may be formed in the range from 500 to 1700.

11. The solid body of claim 8, wherein the micro-scale unevenness are formed by the adjacent pillars that are partly stuck to each other.

12. The solid body of claim 8, wherein the pillars formed on the base are formed of a hydrophobic polymer material.

13. The solid body of claim 12, wherein the hydrophobic polymer material is selected from the group consisting of PTFE (Polytetrahluorethylene), FEP (Fluorinated ethylene propylene copolymer), PFA (Perfluoroalkoxy), and a combination thereof.
